(19) United States
(12) Patent Application Publication
(10) Pub. No.: US 2014/0232331 A1
(43) Pub. Date: Aug. 21, 2014

(54) VEHICLE WIRELESS CHARGING PAD MOUNTING SYSTEMS

(71) Applicant: QUALCOMM Incorporated, San Diego, CA (US)

(72) Inventors: Milenko Stamenic, Munich (DE); Alberto Garcia Briz, Munich (DE); Simon Islinger, Munich (DE); Thomas A. Wuerz, Munich (DE); Scott C. Asbill, San Diego, CA (US); Steven D. Niederhauser, San Diego, CA (US)

(73) Assignee: QUALCOMM Incorporated, San Diego, CA (US)

(21) Appl. No.: 14/026,876

(22) Filed: Sep. 13, 2013

Related U.S. Application Data
(60) Provisional application No. 61/765,589, filed on Feb. 15, 2013.

(51) Int. Cl. B60L 11/18

(52) U.S. Cl. CPC B60L 11/182
USPC 320/108

(57) ABSTRACT

This disclosure provides systems, methods, and apparatuses for mounting vehicle wireless charging pads to other structures, such as a vehicle underbody or frame. In one aspect, a mounting system including a cover adapted to enclose a vehicle wireless charging pad is provided. The cover includes mounting brackets integrally formed in the cover and configured to attach the charging pad to another structure, such as a vehicle underbody or frame. In another aspect, a mounting system includes shield attachment interfaces integrally formed in a vehicle pad shield and configured to attach the shield to the vehicle pad cover. In another implementation, the shield attachment interfaces are integrally formed in the vehicle pad cover and configured to attach the vehicle pad cover to the vehicle pad shield.

### CROSS-REFERENCE TO RELATED APPLICATIONS

This application claims priority to and the benefit under 35 U.S.C. §119(e) to U.S. Provisional Application No. 61/765,589, filed Feb. 15, 2013, entitled “VEHICLE WIRELESS CHARGING PAD MOUNTING SYSTEMS,” the disclosure of which is hereby incorporated by reference in its entirety.

### FIELD

The present disclosure relates generally to wireless power transfer, and more specifically to devices, systems, and methods related to wireless power transfer to remote systems such as vehicles including batteries, and in particular to mounting systems for charging pads, such as vehicle charging pads.

### BACKGROUND

Remote systems, such as vehicles, have been introduced that include locomotion power derived from electricity received from an energy storage device such as a battery. For example, hybrid electric vehicles include on-board chargers that use power from vehicle braking and traditional motors to charge the vehicles. Vehicles that are solely electric generally receive the electricity for charging the batteries from other sources. Battery electric vehicles (electric vehicles) are often proposed to be charged through some type of wired alternating current (AC) such as household or commercial AC supply sources. The wired charging connections require cables or other similar connectors that are physically connected to a power supply. Cables and similar connectors may sometimes be inconvenient or cumbersome and have other drawbacks. Wireless charging systems that are capable of transferring power in free space (e.g., via a wireless field) to be used to charge electric vehicles may overcome some of the deficiencies of wired charging solutions. As such, wireless charging systems and methods that efficiently and safely transfer power for charging electric vehicles are desirable.

Improved systems for mounting vehicle charging pads used in wireless charging systems are also desired. A vehicle charging pad, or “vehicle pad,” can include a coil structure which, in some cases, is a heavy component. A cover or housing enclosing the vehicle pad can be attached directly to a vehicle underbody or to a vehicle pad shield mounted on the vehicle. The cover, which can be designed to support the entire weight of the vehicle pad, can be attached to a vehicle pad shield with screws going through the vehicle pad shield and secured into the vehicle pad cover. Such screws, however, when made of metal can create magnetic issues and disturbances during operation of the vehicle pad. Further, existing attachment systems can result in very weak holding strengths. Additionally, this vehicle pad attachment method introduces a high risk of the vehicle pad detaching upon exposure to mechanical shocks and vibrations that are typical in the automotive environment.

Thus, improved systems for mounting vehicle pads in the automotive environment are desired and remain a significant challenge in the design of wireless charging technologies.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides a vehicle wireless charging pad mounting system. The system includes a vehicle pad shield and a vehicle pad cover adapted to enclose a vehicle wireless charging pad. The vehicle pad shield has a base area comprising a generally planar surface. The vehicle pad shield includes shield attachment interfaces adapted to attach the vehicle pad cover to the vehicle pad shield, the shield attachment interfaces integrally formed in the vehicle pad shield and extending in a direction generally perpendicular to the base area of the vehicle pad shield.

Another aspect of the disclosure provides a system for mounting a vehicle wireless charging pad to the underbody or the frame of a vehicle. The system includes a vehicle pad cover enclosing the vehicle wireless charging pad. The vehicle pad cover has a generally planar surface and shield attachment interfaces adapted to attach the vehicle pad cover to a vehicle pad shield. The shield attachment interfaces are integrally formed in the cover and extend in a direction generally perpendicular to the base area of the cover.

Yet another aspect of the disclosure provides a vehicle wireless charging pad mounting system. The system includes a vehicle pad cover adapted to enclose a vehicle wireless charging pad. The system also includes means for shielding the vehicle wireless charging pad, the shielding means including means for attaching the shielding means to the vehicle pad cover. The attaching means is integrally formed in the shielding means and extends in a direction generally perpendicular to the shielding means.

### BRIEF DESCRIPTION OF THE DRAWINGS

FIG. 1 is a diagram of an exemplary wireless power transfer system for charging an electric vehicle; in accordance with an exemplary embodiment of the invention.

FIG. 2 is a schematic diagram of exemplary core components of the wireless power transfer system of FIG. 1.

FIG. 3 is a functional block diagram showing exemplary core and ancillary components of the wireless power transfer system of FIG. 1.

FIG. 4 is a functional block diagram showing a replaceable contactless battery disposed in an electric vehicle, in accordance with an exemplary embodiment of the invention.

FIGS. 5A, 5B, 5C, and 5D are diagrams of exemplary configurations for the placement of an induction coil and ferrite material relative to a battery, in accordance with exemplary embodiments of the invention.

FIG. 6A is a perspective view of an implementation of vehicle pad mounting system in accordance with an exemplary embodiment of the invention.

FIG. 6B is an exploded perspective view of a components of the vehicle pad mounting system of FIG. 6A.

FIG. 7A is a perspective view of an implementation of a vehicle pad mounting system that does not include mounting brackets.

FIG. 7B is a perspective view of a vehicle pad cover and coil structures of the implementation of FIG. 7A.

FIG. 7C is a perspective view of a vehicle pad shield of the implementation of FIG. 7A.

FIG. 7D is top plan view of the implementation of FIG. 7A with the vehicle pad cover removed to show features below the vehicle pad cover.

FIG. 7E is a cross-sectional detail view of section E of FIG. 7D.

FIG. 8A is an elevational view of a vehicle pad mounting system in accordance with another exemplary embodiment of the invention.

FIG. 8B is a detail view of section B of FIG. 8A.

FIG. 8C is a partial perspective view of the implementation of FIG. 8A.

FIG. 9A is an illustration of a magnetic simulation of a vehicle pad shield included in a vehicle pad mounting system in accordance with yet another exemplary embodiment of the invention.

FIG. 9B is an illustration of a magnetic simulation of a vehicle pad cover included in the implementation of FIG. 9A.

FIG. 10 is an illustration a vehicle pad mounting system in accordance with still another exemplary embodiment of the invention.

FIG. 11 is an illustration of a magnetic simulation of a vehicle pad mounting system in accordance with still a further exemplary embodiment of the invention.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of exemplary embodiments of the invention and is not intended to represent the only embodiments in which the invention may be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. In some instances, some devices are shown in block diagram form.

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving coil” to achieve power transfer.

An electric vehicle is used herein to describe a remote system, an example of which is a vehicle that includes, as part of its locomotion capabilities, electrical power derived from a chargeable energy storage device (e.g., one or more rechargeable electrochemical cells or other type of battery). As non-limiting examples, some electric vehicles may be hybrid electric vehicles that include besides electric motors, a traditional combustion engine for direct locomotion or to charge the vehicle's battery. Other electric vehicles may draw all locomotion ability from electrical power. An electric vehicle is not limited to an automobile and may include motorcycles, carts, scooters, and the like. By way of example and not limitation, a remote system is described herein in the form of an electric vehicle (EV). Furthermore, other remote systems that may be at least partially powered using a chargeable energy storage device are also contemplated (e.g., electronic devices such as personal computing devices and the like).

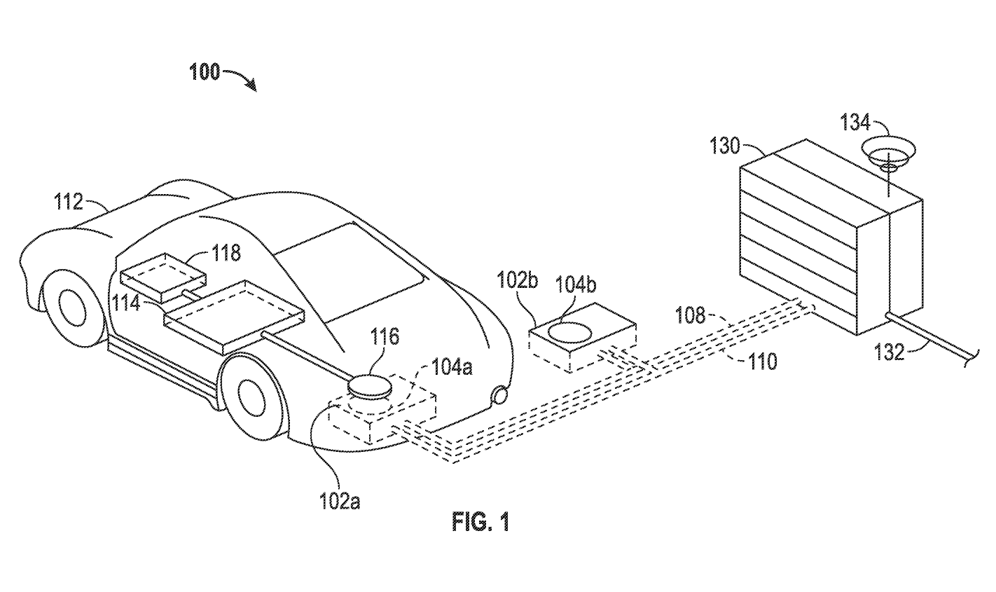

FIG. 1 is a diagram of an exemplary wireless power transfer system 100 for charging an electric vehicle 112, in accordance with an exemplary embodiment of the invention. The wireless power transfer system 100 enables charging of an electric vehicle 112 while the electric vehicle 112 is parked near a base wireless charging system 102a. Spaces for two electric vehicles are illustrated in a parking area to be parked over corresponding base wireless charging system 102a and 102b. In some embodiments, a local distribution center 130 may be connected to a power backbone 132 and configured to provide an alternating current (AC) or a direct current (DC) supply through a power link 110 to the base wireless charging system 102a. The base wireless charging system 102a also includes a base system induction coil 104a for wirelessly transferring or receiving power. An electric vehicle 112 may include a battery unit 118, an electric vehicle induction coil 116, and an electric vehicle wireless charging system 114. The electric vehicle induction coil 116 may interact with the base system induction coil 104a for example, via a region of the electromagnetic field generated by the base system induction coil 104a.

In some exemplary embodiments, the electric vehicle induction coil 116 may receive power when the electric vehicle induction coil 116 is located in an energy field produced by the base system induction coil 104a. The field corresponds to a region where energy output by the base system induction coil 104a may be captured by an electric vehicle induction coil 116. For example, the energy output by the base system induction coil 104a may be at a level sufficient to charge or power the electric vehicle 112. In some cases, the field may correspond to the “near field” of the base system induction coil 104a. The near-field may correspond to a region in which there are strong reactive fields resulting from the currents and charges in the base system induction coil 104a that do not radiate power away from the base system induction coil 104a. In some cases the near-field may correspond to a region that is within about ½π of wavelength of the base system induction coil 104a (and vice versa for the electric vehicle induction coil 116).

Local distribution center 130 may be configured to communicate with external sources (e.g., a power grid) via a communication backhaul 134, and with the base wireless charging system 102a via a communication link 108.

In some embodiments the electric vehicle induction coil 116 may be aligned with the base system induction coil 104a and, therefore, disposed within a near-field region simply by the driver positioning the electric vehicle 112 correctly relative to the base system induction coil 104a. In other embodiments, the driver may be given visual feedback, auditory feedback, or combinations thereof to determine when the electric vehicle 112 is properly placed for wireless power transfer. In yet other embodiments, the electric vehicle 112 may be positioned by an autopilot system, which may move the electric vehicle 112 back and forth (e.g., in zig-zag movements) until an alignment error has reached a tolerable value. This may be performed automatically and autonomously by the electric vehicle 112 without or with only minimal driver intervention provided that the electric vehicle 112 is equipped with a servo steering wheel, ultrasonic sensors, and intelligence to adjust the vehicle. In still other embodiments, the electric vehicle induction coil 116, the base system induction coil 104a, or a combination thereof may have functionality for displacing and moving the induction coils 116 and 104a relative to each other to more accurately orient them and develop more efficient coupling therebetween.

The base wireless charging system 102a may be located in a variety of locations. As non-limiting examples, some suitable locations include a parking area at a home of the electric vehicle 112 owner, parking areas reserved for electric vehicle wireless charging modeled after conventional petroleum-based filling stations, and parking lots at other locations such as shopping centers and places of employment.

Charging electric vehicles wirelessly may provide numerous benefits. For example, charging may be performed automatically, virtually without driver intervention and manipulations thereby improving convenience to a user. There may also be no exposed electrical contacts and no mechanical wear out, thereby improving reliability of the wireless power transfer system 100. Manipulations with cables and connectors may not be needed, and there may be no cables, plugs, or sockets that may be exposed to moisture and water in an outdoor environment, thereby improving safety. There may also be no sockets, cables, and plugs visible or accessible, thereby reducing potential vandalism of power charging devices. Further, since an electric vehicle 112 may be used as distributed storage devices to stabilize a power grid, a docking-to-grid solution may be used to increase availability of vehicles for Vehicle-to-Grid (V2G) operation.

A wireless power transfer system 100 as described with reference to FIG. 1 may also provide aesthetical and non-impedimental advantages. For example, there may be no charge columns and cables that may be impedimental for vehicles and/or pedestrians.

As a further explanation of the vehicle-to-grid capability, the wireless power transmit and receive capabilities may be configured to be reciprocal such that the base wireless charging system 102a transfers power to the electric vehicle 112 and the electric vehicle 112 transfers power to the base wireless charging system 102a e.g., in times of energy shortfall. This capability may be useful to stabilize the power distribution grid by allowing electric vehicles to contribute power to the overall distribution system in times of energy shortfall caused by over demand or shortfall in renewable energy production (e.g., wind or solar).

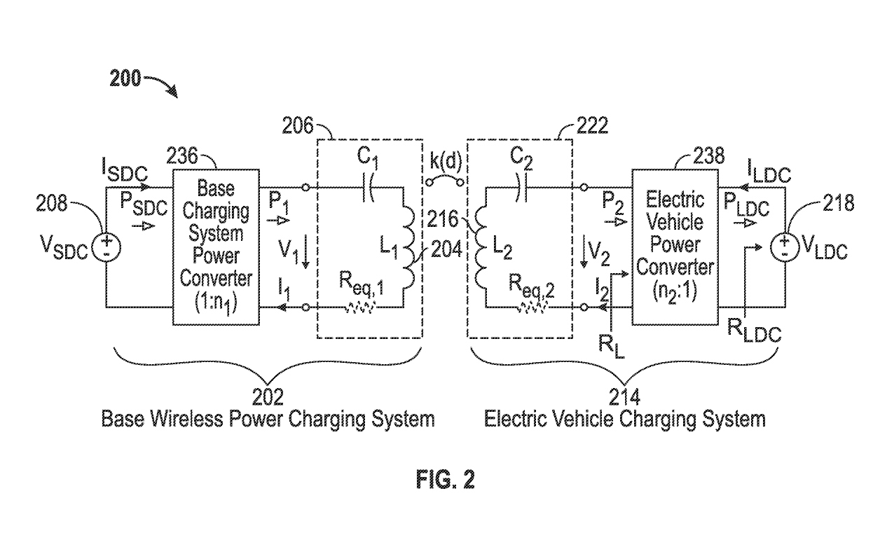

FIG. 2 is a schematic diagram of exemplary core components of the wireless power transfer system 100 of FIG. 1. As shown in FIG. 2, the wireless power transfer system 200 may include a base system transmit circuit 206 including a base system induction coil 204 having an inductance L₁. The wireless power transfer system 200 further includes an electric vehicle receive circuit 222 including an electric vehicle induction coil 216 having an inductance L₂. Embodiments described herein may use capacitively loaded wire loops (i.e., multi-turn coils) forming a resonant structure that is capable of efficiently coupling energy from a primary structure (transmitter) to a secondary structure (receiver) via a magnetic or electromagnetic near field if both primary and secondary are tuned to a common resonant frequency. The coils may be used for the electric vehicle induction coil 216 and the base system induction coil 204. Using resonant structures for coupling energy may be referred to “magnetic coupled resonance,” “electromagnetic coupled resonance,” and/or “resonant induction.” The operation of the wireless power transfer system 200 will be described based on power transfer from a base wireless power charging system 202 to an electric vehicle 112, but is not limited thereto. For example, as discussed above, the electric vehicle 112 may transfer power to the base wireless charging system 102a.

With reference to FIG. 2, a power supply 208 (e.g., AC or DC) supplies power P_{SDC} to the base wireless power charging system 202 to transfer energy to an electric vehicle 112. The base wireless power charging system 202 includes a base charging system power converter 236. The base charging system power converter 236 may include circuitry such as an AC/DC converter configured to convert power from standard mains AC to DC power at a suitable voltage level, and a DC/low frequency (LF) converter configured to convert DC power to power at an operating frequency suitable for wireless high power transfer. The base charging system power converter 236 supplies power P₁ to the base system transmit circuit 206 including the capacitor C₁ in series with the base system induction coil 204 to emit an electromagnetic field at a desired frequency. The capacitor C₁ may be provided to form a resonant circuit with the base system induction coil 204 that resonates at a desired frequency. The base system induction coil 204 receives the power P₁ and wirelessly transmits power at a level sufficient to charge or power the electric vehicle 112. For example, the power level provided wirelessly by the base system induction coil 204 may be on the order of kilowatts (kW) (e.g., anywhere from 1 kW to 110 kW or higher or lower).

The base system transmit circuit 206 including the base system induction coil 204 and electric vehicle receive circuit 222 including the electric vehicle induction coil 216 may be tuned to substantially the same frequencies and may be positioned within the near-field of an electromagnetic field transmitted by one of the base system induction coil 204 and the electric vehicle induction coil 216. In this case, the base system induction coil 204 and electric vehicle induction coil 216 may become coupled to one another such that power may be transferred to the electric vehicle receive circuit 222 including capacitor C₂ and electric vehicle induction coil 216. The capacitor C₂ may be provided to form a resonant circuit with the electric vehicle induction coil 216 that resonates at a desired frequency. Element k(d) represents the mutual coupling coefficient resulting at coil separation. Equivalent resistances R_{eq,1} and R_{eq,2} represent the losses that may be inherent to the induction coils 204 and 216 and the anti-reactance capacitors C₁ and C₂. The electric vehicle receive circuit 222 including the electric vehicle induction coil 316 and capacitor C₂ receives power P₂ and provides the power P₂ to an electric vehicle power converter 238 of an electric vehicle charging system 214.

The electric vehicle power converter 238 may include, among other things, a LF/DC converter configured to convert power at an operating frequency back to DC power at a voltage level matched to the voltage level of an electric vehicle battery unit 218. The electric vehicle power converter 238 may provide the converted power P_{LDC} to charge the electric vehicle battery unit 218. The power supply 208, base charging system power converter 236, and base system induction coil 204 may be stationary and located at a variety of locations as discussed above. The battery unit 218, electric vehicle power converter 238, and electric vehicle induction coil 216 may be included in an electric vehicle charging system 214 that is part of electric vehicle 112 or part of the battery pack (not shown). The electric vehicle charging system 214 may also be configured to provide power wirelessly through the electric vehicle induction coil 216 to the base wireless power charging system 202 to feed power back to the grid. Each of the electric vehicle induction coil 216 and the base system induction coil 204 may act as transmit or receive induction coils based on the mode of operation.

While not shown, the wireless power transfer system 200 may include a load disconnect unit (LDU) to safely disconnect the electric vehicle battery unit 218 or the power supply 208 from the wireless power transfer system 200. For example, in case of an emergency or system failure, the LDU may be triggered to disconnect the load from the wireless power transfer system 200. The LDU may be provided in addition to a battery management system for managing charging to a battery, or it may be part of the battery management system.

Further, the electric vehicle charging system 214 may include switching circuitry (not shown) for selectively connecting and disconnecting the electric vehicle induction coil 216 to the electric vehicle power converter 238. Disconnecting the electric vehicle induction coil 216 may suspend charging and also may adjust the “load” as “seen” by the base wireless charging system 102a (acting as a transmitter), which may be used to “cloak” the electric vehicle charging system 114 (acting as the receiver) from the base wireless charging system 102a. The load changes may be detected if the transmitter includes the load sensing circuit. Accordingly, the transmitter, such as a base wireless charging system 202, may have a mechanism for determining when receivers, such as an electric vehicle charging system 114, are present in the near-field of the base system induction coil 204.

As described above, in operation, assuming energy transfer towards the vehicle or battery, input power is provided from the power supply 208 such that the base system induction coil 204 generates a field for providing the energy transfer. The electric vehicle induction coil 216 couples to the radiated field and generates output power for storage or consumption by the electric vehicle 112. As described above, in some embodiments, the base system induction coil 204 and electric vehicle induction coil 216 are configured according to a mutual resonant relationship such that the resonant frequency of the electric vehicle induction coil 216 and the resonant frequency of the base system induction coil 204 are very close or substantially the same. Transmission losses between the base wireless power charging system 202 and electric vehicle charging system 214 are minimal when the electric vehicle induction coil 216 is located in the near-field of the base system induction coil 204.

As stated, an efficient energy transfer occurs by coupling a large portion of the energy in the near field of a transmitting induction coil to a receiving induction coil rather than propagating most of the energy in an electromagnetic wave to the far-field. When in the near field, a coupling mode may be established between the transmit induction coil and the receive induction coil. The area around the induction coils where this near field coupling may occur is referred to herein as a near field coupling mode region.

While not shown, the base charging system power converter 236 and the electric vehicle power converter 238 may both include an oscillator, a driver circuit such as a power amplifier, a filter, and a matching circuit for efficient coupling with the wireless power induction coil. The oscillator may be configured to generate a desired frequency, which may be adjusted in response to an adjustment signal. The oscillator signal may be amplified by a power amplifier with an amplification amount responsive to control signals. The filter and matching circuit may be included to filter out harmonics or other unwanted frequencies and match the impedance of the power conversion module to the wireless power induction coil. The power converters 236 and 238 may also include a rectifier and switching circuitry to generate a suitable power output to charge the battery.

The electric vehicle induction coil 216 and base system induction coil 204 as described throughout the disclosed embodiments may be referred to or configured as “loop” antennas, and more specifically, multi-turn loop antennas. The induction coils 204 and 216 may also be referred to herein or be configured as “magnetic” antennas. The term “coil” generally refers to a component that may wirelessly output or receive energy four coupling to another “coil.” The coil may also be referred to as an “antenna” of a type that is configured to wirelessly output or receive power. As used herein, coils 204 and 216 are examples of “power transfer components” of a type that are configured to wirelessly output, wirelessly receive, and/or wirelessly relay power. Loop (e.g., multi-turn loop) antennas may be configured to include an air core or a physical core such as a ferrite core. An air core loop antenna may allow the placement of other components within the core area. Physical core antennas including ferromagnetic or ferromagnetic materials may allow development of a stronger electromagnetic field and improved coupling.

As discussed above, efficient transfer of energy between a transmitter and receiver occurs during matched or nearly matched resonance between a transmitter and a receiver. However, even when resonance between a transmitter and receiver are not matched, energy may be transferred at a lower efficiency. Transfer of energy occurs by coupling energy from the near field of the transmitting induction coil to the receiving induction coil residing within a region (e.g., within a predetermined frequency range of the resonant frequency, or within a predetermined distance of the near-field region) where this near field is established rather than propagating the energy from the transmitting induction coil into free space.

A resonant frequency may be based on the inductance and capacitance of a transmit circuit including an induction coil (e.g., the base system induction coil 204) as described above. As shown in FIG. 2, inductance may generally be the inductance of the induction coil, whereas, capacitance may be added to the induction coil to create a resonant structure at a desired resonant frequency. As a non-limiting example, as shown in FIG. 2, a capacitor may be added in series with the induction coil to create a resonant circuit (e.g., the base system transmit circuit 206) that generates an electromagnetic field. Accordingly, for larger diameter induction coils, the value of capacitance needed to induce resonance may decrease as the diameter or inductance of the coil increases. Inductance may also depend on a number of turns of an induction coil. Furthermore, as the diameter of the induction coil increases, the efficient energy transfer area of the near field may increase. Other resonant circuits are possible. As another non limiting example, a capacitor may be placed in parallel between the two terminals of the induction coil (e.g., a parallel resonant circuit). Furthermore an induction coil may be designed to have a high quality (Q) factor to improve the resonance of the induction coil. For example, the Q factor may be 300 or greater.

As described above, according to some embodiments, coupling power between two induction coils that are in the near field of one another is disclosed. As described above, the near field may correspond to a region around the induction coil in which electromagnetic fields exist but may not propagate or radiate away from the induction coil. Near-field coupling-mode regions may correspond to a volume that is near the physical volume of the induction coil, typically within a small fraction of the wavelength. According to some embodiments, electromagnetic induction coils, such as single and multi-turn loop antennas, are used for both transmitting and receiving since magnetic near field amplitudes in practical embodiments tend to be higher for magnetic type coils in comparison to the electric near fields of an electric type antenna (e.g., a small dipole). This allows for potentially higher coupling between the pair. Furthermore, “electric” antennas (e.g., dipoles and monopoles) or a combination of magnetic and electric antennas may be used.

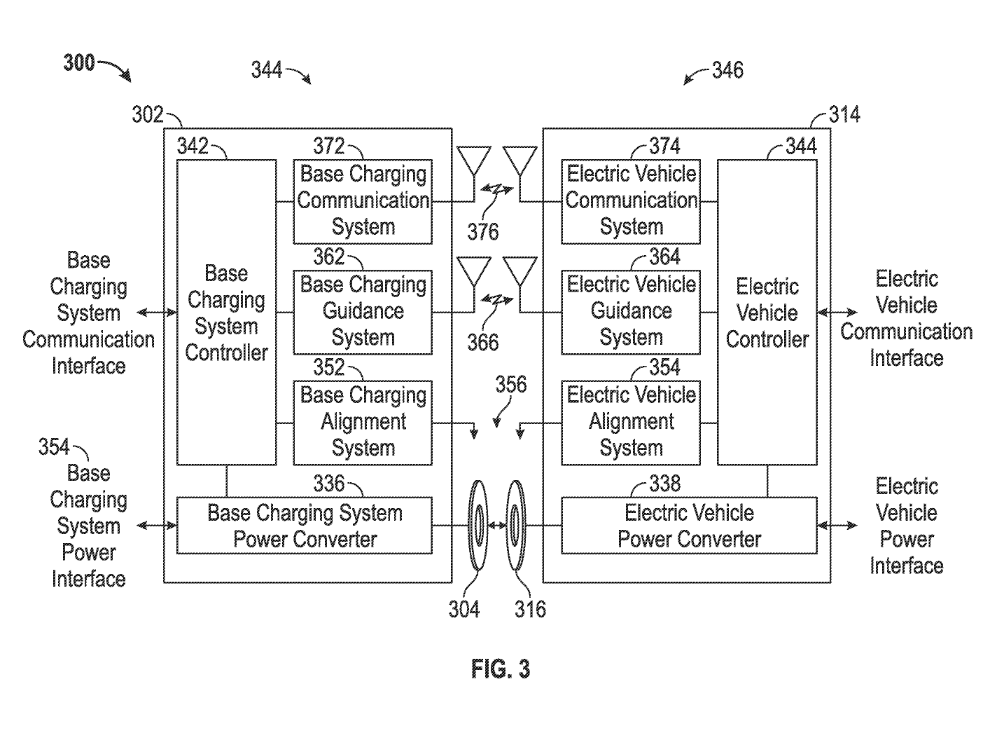

FIG. 3 is another functional block diagram showing exemplary core and ancillary components of the wireless power transfer system 300 of FIG. 1. The wireless power transfer system 300 illustrates a communication link 376, a guidance link 366, and alignment systems 352, 354 for the base system induction coil 304 and electric vehicle induction coil 316. As described above with reference to FIG. 2, and assuming energy flow towards the electric vehicle 112, in FIG. 3 a base charging system power interface 354 may be configured to provide power to a charging system power converter 336 from a power source, such as an AC or DC power supply 126. The base charging system power converter 336 may receive AC or DC power from the base charging system power interface 354 to excite the base system induction coil 304 at or near its resonant frequency. The electric vehicle induction coil 316, when in the near field coupling-mode region, may receive energy from the near field coupling mode region to oscillate at or near the resonant frequency. The electric vehicle power converter 338 converts the oscillating signal from the electric vehicle induction coil 316 to a power signal suitable for charging a battery via the electric vehicle power interface.

The base wireless charging system 302 includes a base charging system controller 342 and the electric vehicle charging system 314 includes an electric vehicle controller 344. The base charging system controller 342 may include a base charging system communication interface 162 to other systems (not shown) such as, for example, a computer, and a power distribution center, or a smart power grid. The electric vehicle controller 344 may include an electric vehicle communication interface to other systems (not shown) such as, for example, an on-board computer on the vehicle, other battery charging controller, other electronic systems within the vehicles, and remote electronic systems.

The base charging system controller 342 and electric vehicle controller 344 may include subsystems or modules for specific application with separate communication channels. These communications channels may be separate physical channels or separate logical channels. As non-limiting examples, a base charging alignment system 352 may communicate with an electric vehicle alignment system 354 through a communication link 376 to provide a feedback mechanism for more closely aligning the base system induction coil 304 and electric vehicle induction coil 316, either autonomously or with operator assistance. Similarly, a base charging guidance system 362 may communicate with an electric vehicle guidance system 364 through a guidance link to provide a feedback mechanism to guide an operator in aligning the base system induction coil 304 and electric vehicle induction coil 316. In addition, there may be separate general-purpose communication links (e.g., channels) supported by base charging communication system 372 and electric vehicle communication system 374 for communicating other information between the base wireless power charging system 302 and the electric vehicle charging system 314. This information may include information about electric vehicle characteristics, battery characteristics, charging status, and power capabilities of both the base wireless power charging system 302 and the electric vehicle charging system 314, as well as maintenance and diagnostic data for the electric vehicle 112. These communication channels may be separate physical communication channels such as, for example, Bluetooth, zigbee, cellular, etc.

Electric vehicle controller 344 may also include a battery management system (BMS) (not shown) that manages charge and discharge of the electric vehicle principal battery, a parking assistance system based on microwave or ultrasonic radar principles, a brake system configured to perform a semi-automatic parking operation, and a steering wheel servo system configured to assist with a largely automated parking ‘park by wire’ that may provide higher parking accuracy, thus reducing the need for mechanical horizontal induction coil alignment in any of the base wireless charging system 102a and the electric vehicle charging system 114. Further, electric vehicle controller 344 may be configured to communicate with electronics of the electric vehicle 112. For example, electric vehicle controller 344 may be configured to communicate with visual output devices (e.g., a dashboard display), acoustic/audio output devices (e.g., buzzer, speakers), mechanical input devices (e.g., keyboard, touch screen, and pointing devices such as joystick, trackball, etc.), and audio input devices (e.g., microphone with electronic voice recognition).

Furthermore, the wireless power transfer system 300 may include detection and sensor systems. For example, the wireless power transfer system 300 may include sensors for use with systems to properly guide the driver or the vehicle to the charging spot, sensors to mutually align the induction coils with the required separation/coupling, sensors to detect objects that may obstruct the electric vehicle induction coil 316 from moving to a particular height and/or position to achieve coupling, and safety sensors for use with systems to perform a reliable, damage free, and safe operation of the system. For example, a safety sensor may include a sensor for detection of presence of animals or children approaching the wireless power induction coils 104a, 116 beyond a safety radius, detection of metal objects near the base system induction coil 304 that may be heated up (induction heating), detection of hazardous events such as incandescent objects on the base system induction coil 304, and temperature monitoring of the base wireless power charging system 302 and electric vehicle charging system 314 components.

The wireless power transfer system 300 may also support plug-in charging via a wired connection. A wired charge port may integrate the outputs of the two different chargers prior to transferring power to or from the electric vehicle 112. Switching circuits may provide the functionality as needed to support both wireless charging and charging via a wired charge port.

To communicate between a base wireless charging system 302 and an electric vehicle charging system 314, the wireless power transfer system 300 may use both in-band signaling and an RF data modem (e.g., Ethernet over radio in an unlicensed band). The out-of-band communication may provide sufficient bandwidth for the allocation of value-add services to the vehicle user/owner. A low depth amplitude or phase modulation of the wireless power carrier may serve as an in-band signaling system with minimal interference.

In addition, some communication may be performed via the wireless power link without using specific communications antennas. For example, the wireless power induction coils 304 and 316 may also be configured to act as wireless communication transmitters. Thus, some embodiments of the base wireless power charging system 302 may include a controller (not shown) for enabling keying type protocol on the wireless power path. By keying the transmit power level (amplitude shift keying) at predefined intervals with a predefined protocol, the receiver may detect a serial communication from the transmitter. The base charging system power converter 336 may include a load sensing circuit (not shown) for detecting the presence or absence of active electric vehicle receivers in the vicinity of the near field generated by the base system induction coil 304. By way of example, a load sensing circuit monitors the current flowing to the power amplifier, which is affected by the presence or absence of active receivers in the vicinity of the near field generated by base system induction coil 104a. Detection of changes to the loading on the power amplifier may be monitored by the base charging system controller 342 for use in determining whether to enable the oscillator for transmitting energy, to communicate with an active receiver, or a combination thereof.

To enable wireless high power transfer, some embodiments may be configured to transfer power at a frequency in the range from 10-60 kHz. This low frequency coupling may allow highly efficient power conversion that may be achieved using solid state devices. In addition, there may be less coexistence issues with radio systems compared to other bands.

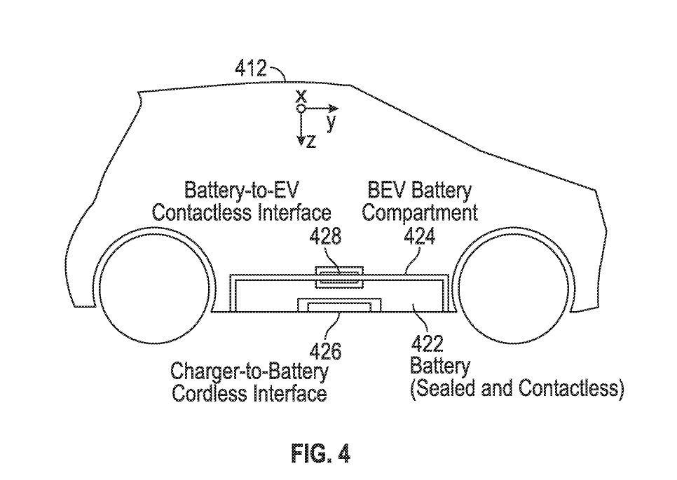

The wireless power transfer system 100 described may be used with a variety of electric vehicles 102 including rechargeable or replaceable batteries. FIG. 4 is a functional block diagram showing a replaceable contactless battery disposed in an electric vehicle 412, in accordance with an exemplary embodiment of the invention. In this embodiment, the low battery position may be useful for an electric vehicle battery unit that integrates a wireless power interface (e.g., a charger-to-battery cordless interface 426) and that may receive power from a charger (not shown) embedded in the ground. In FIG. 4, the electric vehicle battery unit may be a rechargeable battery unit, and may be accommodated in a battery compartment 424. The electric vehicle battery unit also provides a wireless power interface 426, which may integrate the entire electric vehicle wireless power subsystem including a resonant induction coil, power conversion circuitry, and other control and communications functions as needed for efficient and safe wireless energy transfer between a ground-based wireless charging unit and the electric vehicle battery unit.

It may be useful for the electric vehicle induction coil to be integrated flush with a bottom side of electric vehicle battery unit or the vehicle body so that there are no protrusive parts and so that the specified ground-to-vehicle body clearance may be maintained. This configuration may require some room in the electric vehicle battery unit dedicated to the electric vehicle wireless power subsystem. The electric vehicle battery unit 422 may also include a battery-to-EV cordless interface 422, and a charger-to-battery cordless interface 426 that provides contactless power and communication between the electric vehicle 412 and a base wireless charging system 102a as shown in FIG. 1.

In some embodiments, and with reference to FIG. 1, the base system induction coil 104a and the electric vehicle induction coil 116 may be in a fixed position and the induction coils are brought within a near-field coupling region by overall placement of the electric vehicle induction coil 116 relative to the base wireless charging system 102a. However, in order to perform energy transfer rapidly, efficiently, and safely, the distance between the base system induction coil 104a and the electric vehicle induction coil 116 may need to be reduced to improve coupling. Thus, in some embodiments, the base system induction coil 104a and/or the electric vehicle induction coil 116 may be deployable and/or moveable to bring them into better alignment.

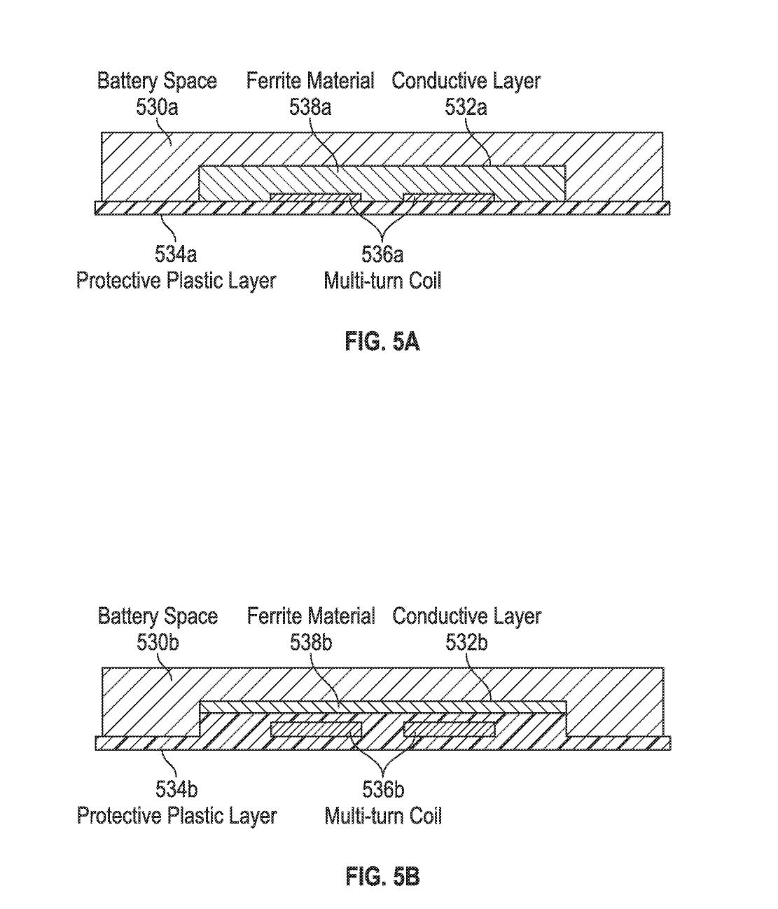

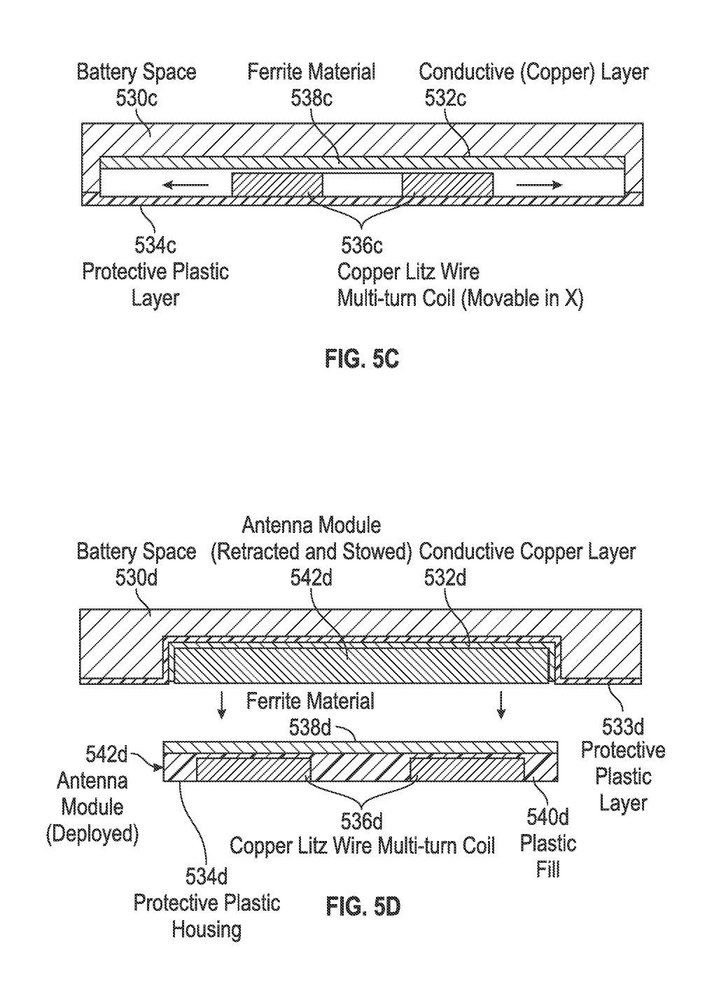

FIGS. 5A, 5B, 5C, and 5D are diagrams of exemplary configurations for the placement of an induction coil and ferrite material relative to a battery, in accordance with exemplary embodiments of the invention. FIG. 5A shows a fully ferrite embedded induction coil 536a. The wireless power induction coil may include a ferrite material 538a and a coil 536a wound about the ferrite material 538a. The coil 536a itself may be made of stranded Litz wire. A conductive shield or layer 532a may be provided to protect passengers of the vehicle from excessive EMF transmission. Conductive shielding may be particularly useful in vehicles made of plastic or composites.

FIG. 5B shows an optimally dimensioned ferrite plate (i.e., ferrite backing) to enhance coupling and to reduce eddy currents (heat dissipation) in the conductive shield 532b. The coil 536b may be fully embedded in a non-conducting non-magnetic (e.g., plastic) material. For example, as illustrated in FIG. 5A-5D, the coil 536b may be embedded in a protective housing 534b. There may be a separation between the coil 536b and the ferrite material 538b as the result of a trade-off between magnetic coupling and ferrite hysteresis losses.

FIG. 5C illustrates another embodiment where the coil 536c (e.g., a copper Litz wire multi-turn coil) may be movable in a lateral (“X”) direction. FIG. 5D illustrates another embodiment where the induction coil module is deployed in a downward direction. In some embodiments, the battery unit includes one of a deployable and non-deployable electric vehicle induction coil module 540d as part of the wireless power interface. To prevent magnetic fields from penetrating into the battery space 530d and into the interior of the vehicle, there may be a conductive shield 532d (e.g., a copper sheet) between the battery space 530d and the vehicle. Furthermore, a non-conductive (e.g., plastic) protective layer 533d may be used to protect the conductive shield 532d, the coil 536d, and the ferrite material 538d from environmental impacts (e.g., mechanical damage, oxidization, etc.). Furthermore, the coil 536d may be movable in lateral X and/or Y directions. FIG. 5D illustrates an embodiment wherein the electric vehicle induction coil module 540d is deployed in a downward Z direction relative to a battery unit body.

The design of this deployable electric vehicle induction coil module 542d is similar to that of FIG. 5B except there is no conductive shielding at the electric vehicle induction coil module 542d. The conductive shield 532d stays with the battery unit body. The protective layer 533d (e.g., plastic layer) is provided between the conductive shield 532d and the electric vehicle induction coil module 542d when the electric vehicle induction coil module 542d is not in a deployed state. The physical separation of the electric vehicle induction coil module 542d from the battery unit body may have a positive effect on the induction coil's performance.

As discussed above, the electric vehicle induction coil module 542d that is deployed may contain only the coil 536d (e.g., Litz wire) and ferrite material 538d. Ferrite backing may be provided to enhance coupling and to prevent from excessive eddy current losses in a vehicle's underbody or in the conductive shield 532d. Moreover, the electric vehicle induction coil module 542d may include a flexible wire connection to power conversion electronics and sensor electronics. This wire bundle may be integrated into the mechanical gear for deploying the electric vehicle induction coil module 542d.

With reference to FIG. 1, the charging systems described above may be used in a variety of locations for charging an electric vehicle 112, or transferring power back to a power grid. For example, the transfer of power may occur in a parking lot environment. It is noted that a “parking area” may also be referred to herein as a “parking space.” To enhance the efficiency of a vehicle wireless power transfer system 100, an electric vehicle 112 may be aligned along an X direction and a Y direction to enable an electric vehicle induction coil 116 within the electric vehicle 112 to be adequately aligned with a base wireless charging system 102a within an associated parking area.

Furthermore, the disclosed embodiments are applicable to parking lots having one or more parking spaces or parking areas, wherein at least one parking space within a parking lot may comprise a base wireless charging system 102a. Guidance systems (not shown) may be used to assist a vehicle operator in positioning an electric vehicle 112 in a parking area to align an electric vehicle induction coil 116 within the electric vehicle 112 with a base wireless charging system 102a. Guidance systems may include electronic based approaches (e.g., radio positioning, direction finding principles, and/or optical, quasi-optical and/or ultrasonic sensing methods) or mechanical-based approaches (e.g., vehicle wheel guides, tracks or stops), or any combination thereof, for assisting an electric vehicle operator in positioning an electric vehicle 112 to enable an induction coil 116 within the electric vehicle 112 to be adequately aligned with a charging induction coil within a charging base (e.g., base wireless charging system 102a).

As discussed above, the electric vehicle charging system 114 may be placed on the underside of the electric vehicle 112 for transmitting and receiving power from a base wireless charging system 102a. For example, an electric vehicle induction coil 116 may be integrated into the vehicle's underbody preferably near a center position providing maximum safety distance in regards to EM exposure and permitting forward and reverse parking of the electric vehicle.

### Vehicle Pad Mounting Systems

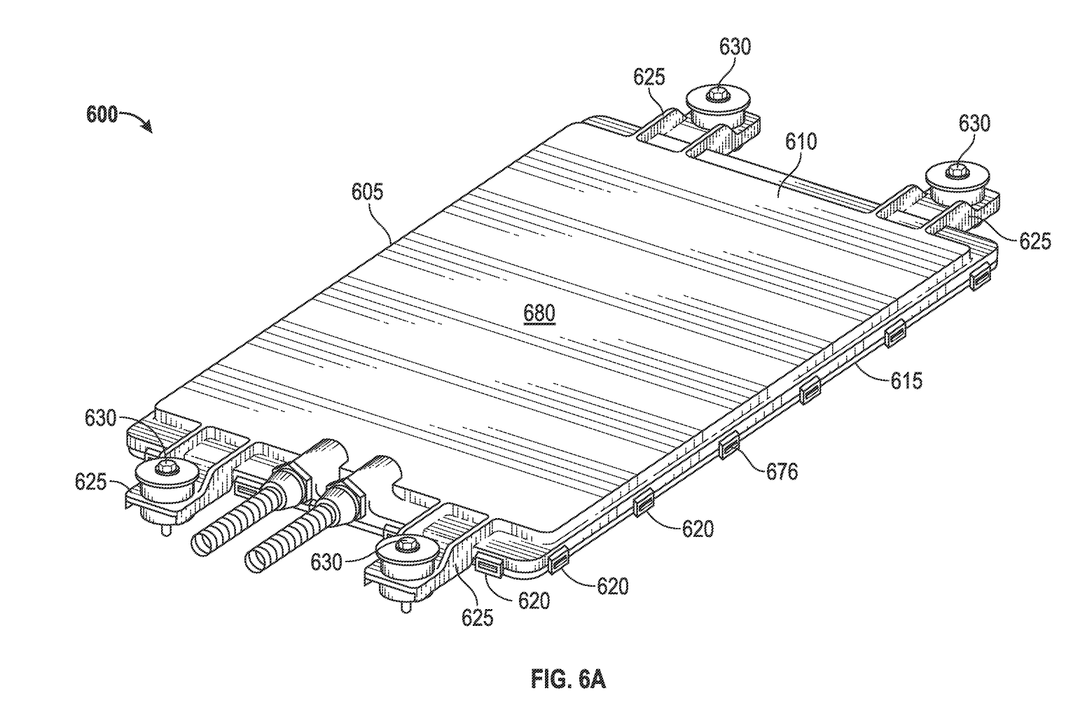

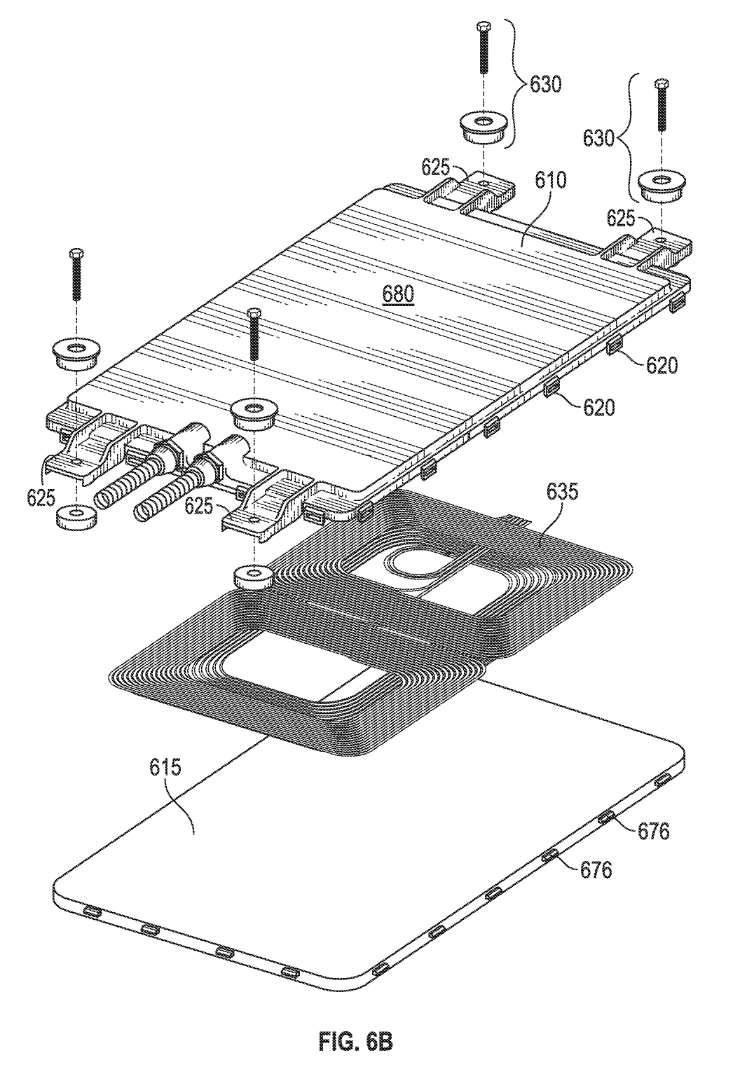

FIG. 6A is a perspective view of a mounting system 600 for an assembled charging pad 605 that can be used to mount an induction coil to another structure. FIG. 6B is an exploded perspective view of a components of the vehicle pad mounting system of FIG. 6A. In an implementation in which the charging pad 605 serves as a vehicle charging pad, the mounting system 600 can be used to mount electric vehicle induction coil 116 to the underside of the electric vehicle 112 of FIG. 1. The system 600 includes a vehicle pad cover or “tray” 610 enclosing a vehicle pad. The vehicle pad can include conductive structures 635 for generating a wireless power field for transferring wireless power, such as coil structures. In accordance with various embodiments described herein, coil structures 635 housed in the vehicle pad cover 610 can include three or more coils in a coil arrangement of a receiver (pick-up) device or base device. The receiver device is also referred to herein as a vehicle pad or vehicle charging pad or vehicle wireless charging pad.

The system 600 also includes a vehicle pad shield or base plate 615. In some implementations, the vehicle pad shield 615 includes aluminum. The vehicle pad cover 610 can be attached to the vehicle pad shield 615 using shield attachment interfaces. In this implementation, the shield attachment interfaces include clips 620 that are integrated in the vehicle pad cover 610. In another implementation (not illustrated), the shield attachment interfaces include clips integrated in the vehicle pad shield 615. Systems and methods for attaching the vehicle pad cover 610 to the vehicle pad shield 615 are described in greater detail below.

The vehicle pad cover 610 also includes mounting brackets 625 that can be formed integral with the vehicle pad cover 610. In the implementation illustrated in FIG. 6, the vehicle pad cover 610 is coupled to the vehicle pad shield 615 using shield attachment interfaces 620 to form an assembled vehicle charging pad 605. The mounting brackets 625 can be used to attach the assembled vehicle charging pad 605 to a vehicle, such as a vehicle's underbody or frame. For example, mounting structures 630 can pass through apertures in the mounting brackets 625 to attach the assembled vehicle charging pad 605 to the vehicle. In another implementation that is not illustrated in FIG. 6, the vehicle pad shield 615 is integral with the vehicle, such as the vehicle's underbody or frame, and the mounting brackets 625 can be used to attach the vehicle pad cover 610 to the vehicle pad shield that is integral with the vehicle. While the illustrated implementation includes four (4) mounting brackets 625, the vehicle pad cover 610 can include fewer or more than four (4) brackets. In one example, the vehicle pad cover 610 includes one (1) mounting bracket 625. In another example, the vehicle pad cover 610 includes two (2) mounting brackets 625.

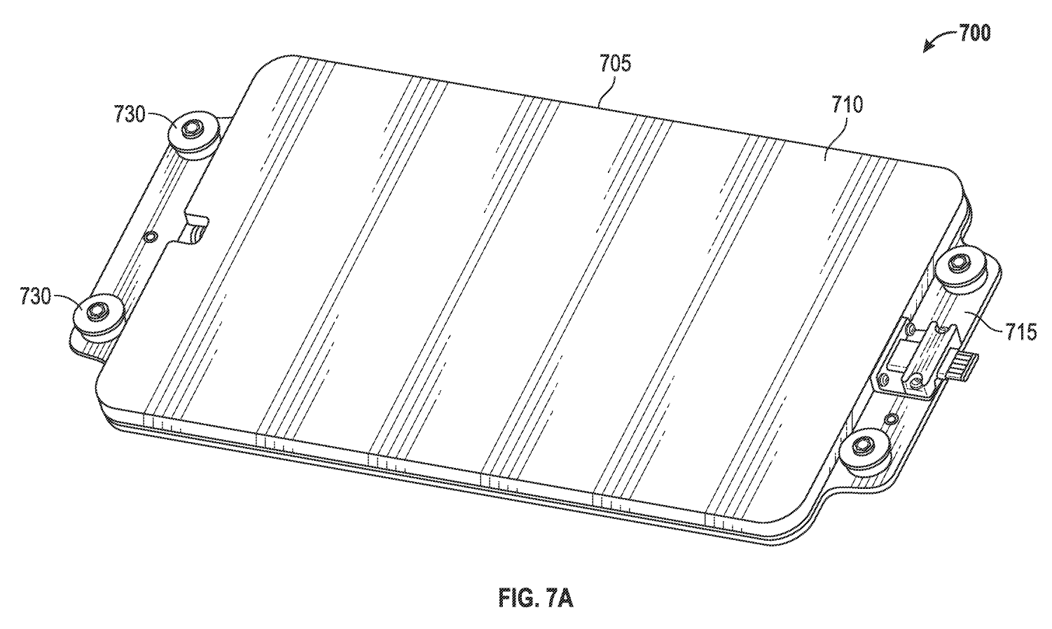

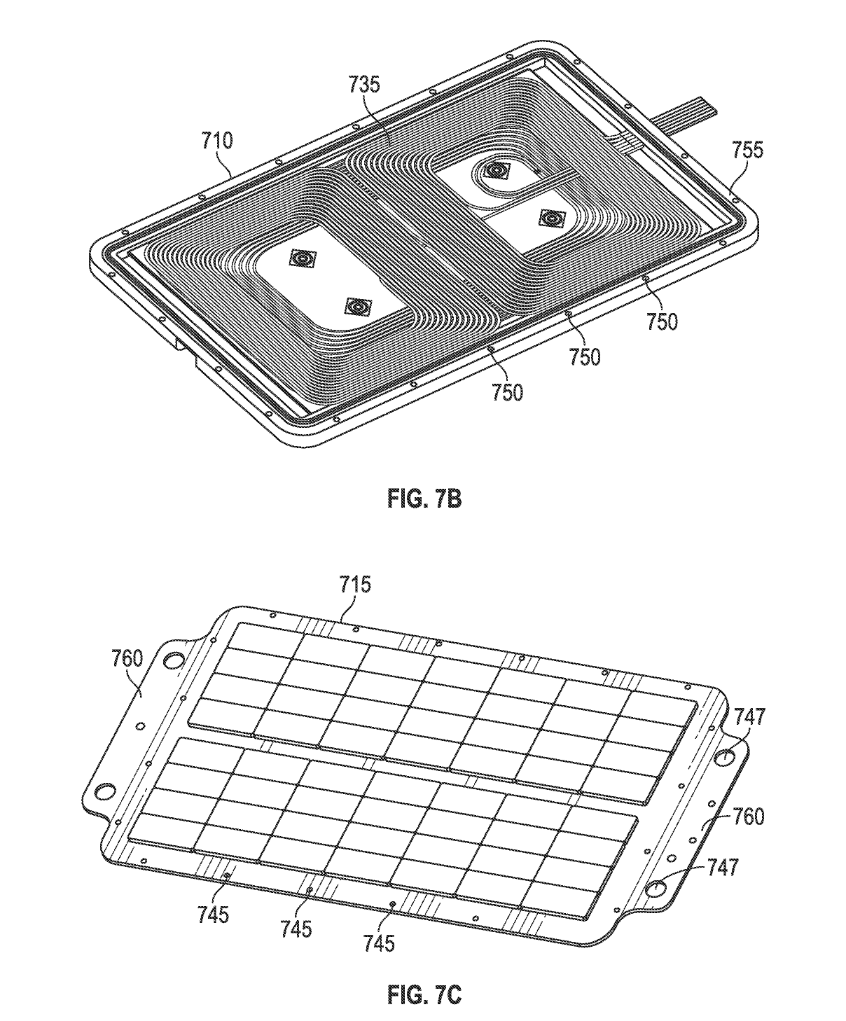

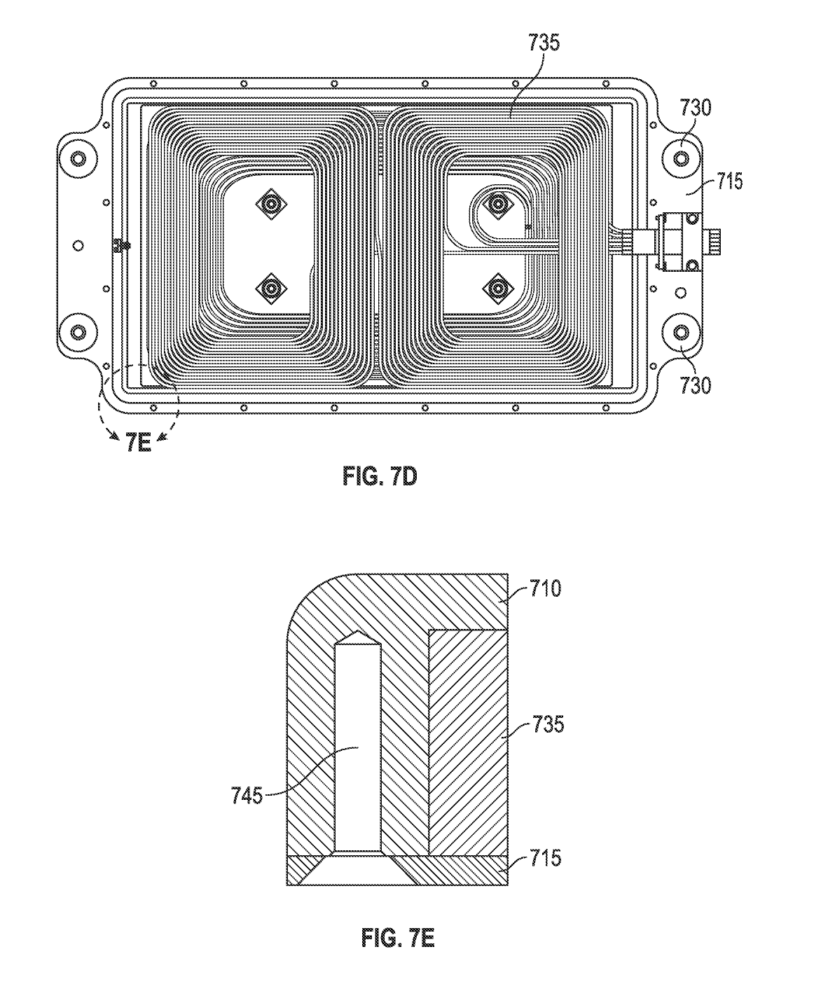

Embodiments of the system 600 can advantageously support the entire vehicle pad, which can include heavy components, in the automotive environment. Additionally, embodiments of the system 600 can be more mechanically robust than implementations that do not use mounting brackets 625, such as the implementation illustrated in FIG. 7A. For example, by forming the mounting brackets 625 integral with the vehicle pad cover 610, significant mechanical strength is provided to reduce the risk of the vehicle pad detaching from the vehicle when exposed to mechanical shocks that are typically present in the automotive environment. Embodiments of the system 600 can also reduce the risk of the vehicle pad cover 610 detaching from the vehicle pad shield 615 due to mechanical shocks and vibrations.

Drawbacks associated with mounting systems which do not include mounting brackets or shield attachment interfaces as described herein will now be described with reference to FIGS. 7A-7E. FIG. 7A is a perspective view of an implementation of an assembled vehicle charging pad 705 having a mounting system 700 that does not include mounting brackets or shield attachment interfaces. The vehicle charging pad 705 includes a vehicle pad cover 710, a vehicle pad shield or base plate 715, and mounting structures 730. FIG. 7B is a perspective view of the vehicle pad cover 710 and coil structures 735 housed in the vehicle pad cover 710. FIG. 7C is a perspective view of the vehicle pad shield 715. FIG. 7D is top plan view of the implementation of FIG. 7A with the vehicle pad cover 710 removed to show features below the vehicle pad cover 710. FIG. 7E is a cross-sectional detail view of section E of FIG. 7D. The vehicle pad mounting system 700 can be configured to mount an electric vehicle induction coil, such as coil structures 735 housed in vehicle pad cover 710, to the underside or frame of an electric vehicle. In one implementation, for example, the mounting system 700 can mount electric vehicle induction coil 116 to the underside or frame of the electric vehicle 112 of FIG. 1.

Drawbacks associated with the mounting system 700's lack of shield attachment interfaces as described herein will now be described. In the implementation illustrated in FIG. 7C, the vehicle pad shield 715 is a generally rectangular planar structure which includes two longitudinally extending tabs 760 extending from each of the shorter sides of the rectangular structure. The vehicle pad shield 715 includes a plurality of peripheral apertures 745 arranged in a rectangular shape near the periphery of the vehicle pad shield 715. The rectangular arrangement of the peripheral apertures 745 corresponds to the shape of a lip 755 of the vehicle pad cover 710, and can be used to secure the vehicle pad shield 715 to the vehicle pad cover 710. The vehicle pad shield 715 need not be generally rectangular, and other shapes are possible.

In this implementation, the vehicle pad cover 710 is attached to the vehicle pad shield 715 with shield screws 740 going through the plurality of peripheral apertures 745 in the vehicle pad shield 715 and secured into the vehicle pad cover 710. In some cases, the shield screws 740 are tapped into apertures 750 provided on the lip 755 of the vehicle pad cover 710. The shield screws 740 can include metal. In the illustrated implementation, twenty (20) shield screws 740 are used to mount the vehicle pad cover 710 to the vehicle pad shield 715, requiring significant time, assembly resources, and alignment mechanisms to drive the shield screws 740 into the apertures 745, 750. More or fewer than twenty (20) shield screws may be used to assemble the vehicle charging pad 705. Further, in this implementation, additional space and material in the vehicle pad cover 710 and the vehicle pad shield 715 are required to provide sufficient space to host the shield screws 740. In one example, each shield screw 740 requires about 5 mm of additional space to host the shield screw 740 in the vehicle pad cover 710 and the vehicle pad shield 715. Additionally, the shield screws 740, when made of metal as in this implementation, can create magnetic issues and disturbances during operation of the vehicle charging pad 705. In cases where the shield screws 740 are not made of metal, this method of attaching the vehicle pad cover 710 to the vehicle pad shield 715 can result in very weak holding strengths.

Drawbacks associated with the mounting system 700's lack of mounting brackets as described herein will now be described. The assembled vehicle charging pad 705 can be attached to a vehicle, such as a vehicle's underbody, using mounting structures or fasteners 730. In the illustrated implementation, mounting apertures 747 are formed near the corners of the longitudinally extending tabs 760 of the vehicle pad shield 715. Fasteners 730, such as bolts, screws, rivets, or nails or any other suitable component, can pass through the mounting apertures 747 to secure an assembled charging pad in place. In an implementation in which the charging pad serves as a vehicle charging pad, the charging pad may be secured to the undercarriage or frame of the vehicle to position the vehicle charging pad underneath the vehicle as discussed above. The mounting system 700 using mounting structures 730 involves drawbacks, however, including a high risk that the assembled vehicle charging pad 705 and/or the vehicle pad cover 710 will detach from the vehicle and/or the vehicle pad shield 715 when exposed to mechanical shocks and vibrations typical in the automotive environment.

Implementations of the mounting system 600 illustrated in FIG. 6 can address these and other drawbacks. Turning again to FIG. 6, the vehicle pad cover 610 houses heavy coil structures. The mounting brackets 625 integrally formed in the vehicle pad cover 610 can directly attach the structure enclosing the relatively heavy induction coils (e.g., the vehicle pad cover 610) to the vehicle, such as the vehicle underbody or frame. In contrast, the implementation illustrated in FIGS. 7A-7D attaches the vehicle pad shield 715 directly to the vehicle underbody or frame, and then couples the structure enclosing the coils (e.g., the vehicle pad cover 710) to the vehicle pad shield 715. Implementations of the mounting system 600 are more mechanically robust and reduce the likelihood that components enclosing heavy structures, such as induction coils, will detach from the vehicle underbody or frame upon exposure to mechanical shocks.

The mounting system 600 can also simplify installation of the assembled vehicle charging pad 605 to the vehicle. In the implementation illustrated in FIG. 6, the vehicle pad cover 610 is coupled to the vehicle pad shield 615 using shield attachment interfaces 620 to form an assembled vehicle charging pad 605. The mounting brackets 625 are then used to attach the assembled vehicle charging pad 605 to a vehicle, such as a vehicle's underbody or frame. In another implementation that is not illustrated in FIG. 6, the vehicle pad shield 615 is integral with the vehicle. In such a case, the vehicle pad cover 610 can be coupled to the vehicle pad shield 615 that is integral with the vehicle using the shield attachment interfaces 620 at or around the same time the mounting brackets 625 are used to attach the vehicle pad cover 610 to the vehicle.

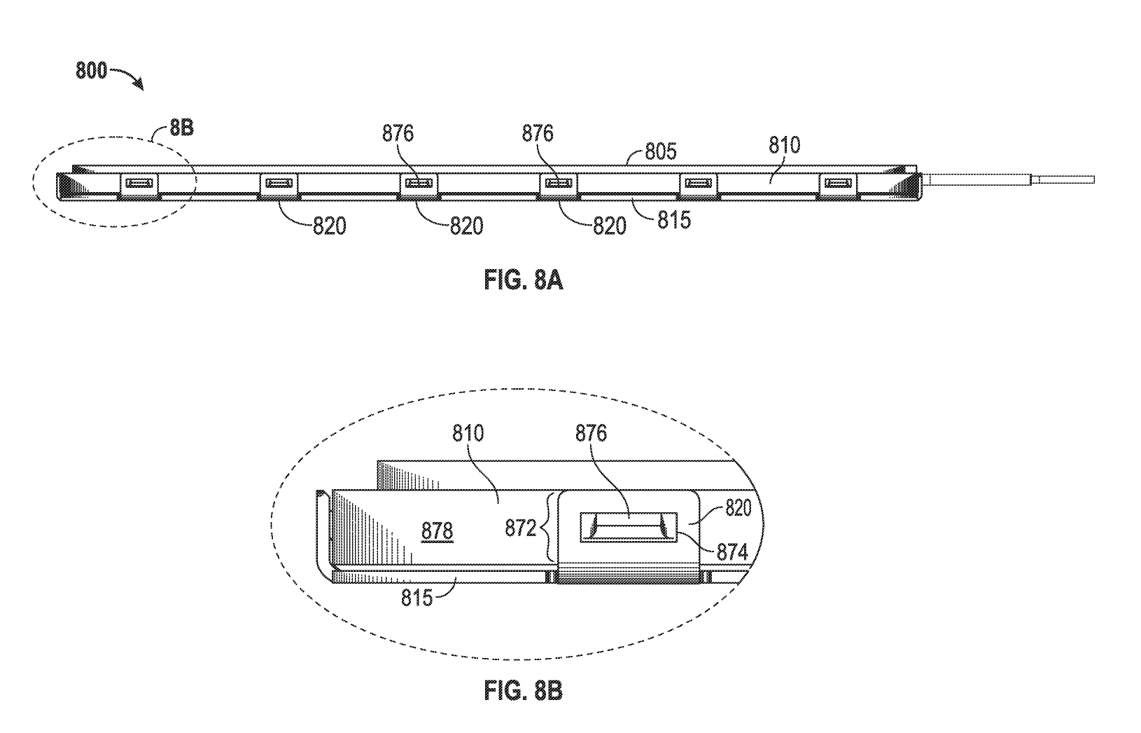

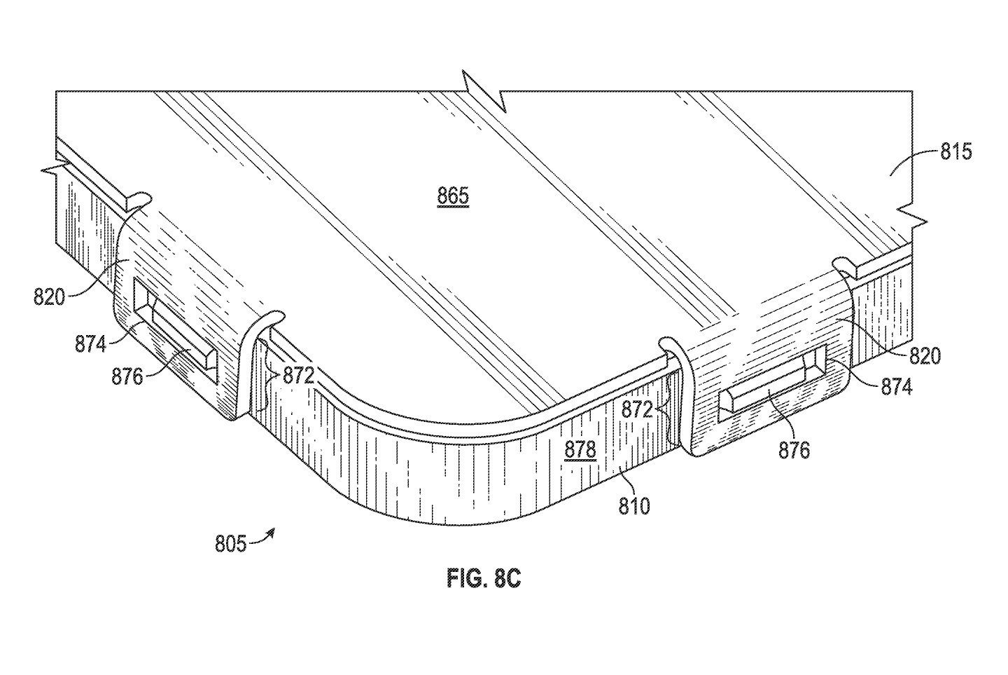

FIG. 8A is an elevational view of a mounting system 800 for a charging pad 805 according to another implementation. FIG. 8B is a detail view of section B of FIG. 8A. FIG. 8C is a partial perspective view of the mounting system 800 of FIG. 8A. In an implementation in which the charging pad 805 serves as a vehicle charging pad, the charging pad 805 may be secured to the undercarriage or frame of the vehicle to position the vehicle charging pad 805 underneath the vehicle as discussed above.

The mounting system 800 includes a vehicle pad cover or “tray” 810. The tray can include plastic or other suitable materials. The mounting system 800 also includes a vehicle pad shield 815. In some cases, the vehicle pad shield includes a metal, such as aluminum. In this implementation, the vehicle pad shield 815 is a rectangular structure including a generally planar surface or base area 865. The vehicle pad shield 815 need not have a generally rectangular shape, and other shapes are possible. The base area 865 of the vehicle pad shield 815 can be configured to shield conductive structures in the vehicle pad which generate a wireless power field.

The vehicle pad shield 815 can be attached to the vehicle pad cover 810 using shield attachment interfaces. In this implementation, the shield attachment interfaces include clips 820 integrally formed in the vehicle pad shield 815. The clips 820 in this example include closed clips having a generally rectangular surface 872 and a generally rectangular aperture 874 in the surface 872. Other shapes and configurations are possible. The closed clips 820 extend in a direction generally perpendicular to the base area 865 of the vehicle pad shield 815. In this implementation, for example, the rectangular surface 872 of the closed clips 820 forms a plane that is generally perpendicular to a plane formed by the base area 865 of the vehicle pad shield 815.

In other implementations, the closed clips 820 do not extend in a direction generally perpendicular to the base area 865, but extend in a plane that is different than the plane formed by the base area 865. For example, the plane formed by the generally rectangular surface 872 of the closed clips 820 can be angled relative to the plane formed by the base area 865.

In the illustrated implementation, the clips 820 are integrally formed with the vehicle pad shield 815, extending from a periphery of the base area 865. In one example, the vehicle pad shield 815 is molded or formed as one piece with the clips 820 extending generally perpendicular to the base area 865. In another implementation that is not illustrated, the clips 820 can be attached to the periphery of the base area 865 by welding or any other suitable attachment mechanism.

The closed clips 820 are configured to accept prongs 876, or other suitable connectors, integrally formed in an outer surface 878 of the vehicle pad cover 810. The prongs 876 are generally rectangular and conform to the generally rectangular shape of the apertures 874 of the closed clips 820. Other shapes are possible.

The vehicle pad shield 815 can be coupled to the vehicle pad cover 810 by inserting the prongs 876 into the closed clips 820 of the vehicle pad shield 815. In some implementations, the clips 820 and the prongs 876 couple together in a snap-fit arrangement.

In some implementations, the shield attachment interfaces include closed clips integrally formed on the vehicle pad cover rather than the vehicle pad shield. Turning again to FIG. 6, the vehicle pad cover 610 includes closed clips 620 integrally formed in the vehicle pad cover 610. The closed clips 620 are configured to accept prongs 676 included along a periphery of the vehicle pad shield 615. In some implementations, the clips 620 and the prongs 676 couple together in a snap-fit arrangement to attach the vehicle pad cover 610 to the vehicle pad shield 615. Advantageously, as noted above, embodiments of the mounting systems 600 and 800 can allow the vehicle pad shield to be attached to the vehicle pad cover prior to the assembled vehicle charging pad being mounted to a vehicle, or alternatively, the vehicle pad cover can be attached to a vehicle pad shield that is already integral with the vehicle underbody or frame. In the implementation illustrated in FIG. 6, mounting brackets 625 can be used to mount the vehicle pad cover 610 to the vehicle underbody at or around the same time the vehicle pad cover 610 and the vehicle pad shield 615 are coupled together.

Additionally, shield attachment interfaces such as closed clips 620 and 820 can advantageously reduce the overall size of the mounting systems described herein. In contrast to the implementation illustrated in FIGS. 7A-7E, implementations of the vehicle pad cover 810 do not include apertures (such as apertures 750 of vehicle pad cover 710), and implementations of vehicle pad shield 815 do not include peripheral apertures (such as peripheral 745 of vehicle pad shield 715). Implementations of the mounting systems 600 and 800 can advantageously connect the vehicle pad cover and the vehicle pad shield using shield attachment interfaces provided and/or formed along the periphery of the base area of the vehicle pad shield and/or vehicle pad cover, such that additional space and material are not required in the vehicle pad cover and vehicle pad shield to accept fasteners such as shield screws 740. In one example described above with reference to FIG. 6, the shield attachment interfaces are provided and/or formed along the periphery of a base area 680 of the vehicle pad cover 610, extending in a direction generally perpendicular to the base area 680. In another example described above with reference to FIG. 8A, the shield attachment interfaces are provided and/or formed along the periphery of the base area 865 of the vehicle pad shield 815, extending in a direction generally perpendicular to the base area 865. Locating the shield attachment interfaces along the periphery of base areas of the vehicle pad cover and/or vehicle pad shield allows the overall size of the vehicle charging pad to be advantageously reduced, as additional space is not required in the vehicle pad cover and the vehicle pad shield to host attachment mechanisms such as the shield screw 740 shown in FIG. 7E. In one example embodiment, shield attachment interfaces described herein use about 2 mm of space in the vehicle pad cover and/or the vehicle pad shield to host the shield attachment interfaces. Implementations of shield attachment interfaces such as closed clips 620 and 820 can also increase the mechanical strength of the mounting systems 600 and 800, and simplify installation and attachment of the vehicle pad cover to the vehicle pad shield.

Additionally, mounting systems having shield attachment interfaces can advantageously include mounting brackets as described herein. Although mounting bracket features are not illustrated in FIGS. 8A-8C, the mounting system 800 can include mounting brackets 825 integrally formed in the vehicle pad cover 810 and configured to mount the assembled vehicle charging pad 805 to another structure, such as a vehicle underbody or frame. In contrast to the implementation illustrated in FIG. 7A, the vehicle pad shield 815 does not include two longitudinally extending tabs extending from each of the shorter sides of the rectangular structure, and does not include mounting apertures (such as mounting apertures 747 of FIG. 7A) arranged on such tabs. As a result, implementations of the vehicle pad shield 815 can advantageously reduce the size of the assembled vehicle charging pad 805.

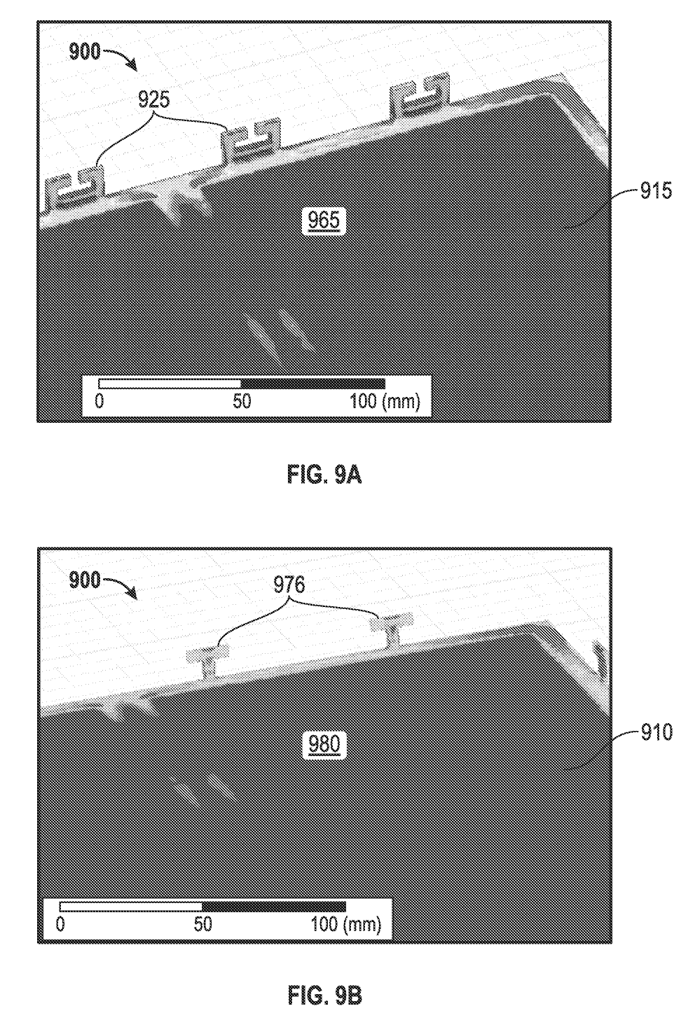

Implementations of the vehicle pad mounting systems described herein can also reduce magnetic loss due to eddy current effects. FIG. 9A is an illustration of a magnetic simulation of a vehicle pad shield 915 included in a mounting system 900 according to another implementation. The vehicle pad shield 915 in this example includes aluminum, but the shield 915 can be made of other suitable materials. FIG. 9B is an illustration of a magnetic simulation of a vehicle pad cover 910 included in the mounting system 900 of FIG. 9A. In this implementation, the vehicle pad shield 915 includes shield attachment interfaces formed along a periphery of a generally planar base area 965. The shield attachment interfaces include clips 925 in the shape of a double-L (“double-L clips”). The double-L clips 925 extend in a direction generally perpendicular to the base area 965 of the vehicle pad shield 915.

The vehicle pad cover 910 includes prongs 976 in the shape of a T (“T-shaped prongs”). The T-shaped prongs 976 extend in a direction generally perpendicular to a generally planar base area 980 of the vehicle pad cover 910. The double-L clips 925 can be adapted to receive the T-shaped prongs 976. In some implementations, the double-L clips 925 and the T-shaped prongs 976 couple together in a snap-fit arrangement to attach the vehicle pad cover 910 to the vehicle pad shield 915.

Implementations of the mounting system 900 can advantageously reduce magnetic loss due to eddy current effects. In some implementations, the negative effect of the mounting system 900 on magnetic fields in the system is relatively minimal or, in some cases, there is no impact on the magnetic fields. Without being bound by any particular theory, higher magnetic losses would ordinarily be expected with the introduction of metal structures, such as double-L clips 925 including aluminum, extending along the periphery of the base area 965 of the vehicle pad shield 915 in a direction generally perpendicular to the base area 965. As such, introducing implementations of the shield attachment interfaces described herein would ordinarily be discouraged to avoid blocking flux fields associated with the assembled vehicle charging pad.

However, implementations of the shield attachment interfaces described herein, such as the double-L clips 925, resulted in less than 0.5% loss of efficiency during magnetic simulation testing, as shown in the test results illustrated in FIGS. 9A-9B. The varying degrees of shading in FIGS. 9A-9B depict the amount of surface heat loss in the vehicle pad shield 915 and the vehicle pad cover 910, respectively. The lighter shaded areas illustrated in FIGS. 9A-9B depict higher surface heat loss, while the darker shaded areas depict very little or substantially no surface heat loss, such that the lighter shaded areas represent larger amounts of surface heat loss than the darker shaded areas. The results of the magnetic simulation depicted in FIGS. 9A-9B illustrate that minimal loss of efficiency and very little magnetic loss is associated with the double-L clips 925 and the T-shaped prongs 976 included in this implementation, contrary to the higher magnetic losses which would ordinarily be expected in this configuration.

Additionally, as described above, implementations of the mounting system 900 can further increase strength and mechanical robustness of the assembled vehicle charging pad, while reducing the size of the charging pad, since the space needed to host shield screws can be eliminated or reduced in an arrangement where the vehicle pad cover 910 is clipped to the vehicle pad shield 915. Further, the space needed to host mounting structures (such as mounting structures 730 shown in FIG. 7A) can be eliminated or reduced in an arrangement where the assembled vehicle charging pad is mounted to another structure, such as a vehicle underbody or frame, using mounting brackets such as those illustrated in FIG. 6.

In another implementation that is not illustrated in FIGS. 9A-9B, shield attachment interfaces such as double-L clips are formed on the vehicle pad cover 910 rather than the vehicle pad shield 915. The double-L clips can be provided and/or formed along the periphery of the generally planar base area 980 of the vehicle pad cover 910. The double-L clips can be integrally formed in the vehicle pad cover 910 in one implementation. The double-L clips formed on the vehicle pad cover can also extend in a direction generally perpendicular to the base area 980 of the vehicle pad cover 910. The double-L clips are configured to accept T-shaped prongs provided and/or formed along a periphery of the generally planar base area 965 of the vehicle pad shield 915. The T-shaped prongs can be integrally formed in the vehicle pad shield 915 according to one implementation. The double-L clips of the vehicle pad cover 910 and the T-shaped prongs of the vehicle shield 915 can couple together in a snap-fit arrangement to attach the vehicle pad cover 910 to the vehicle pad shield 915.

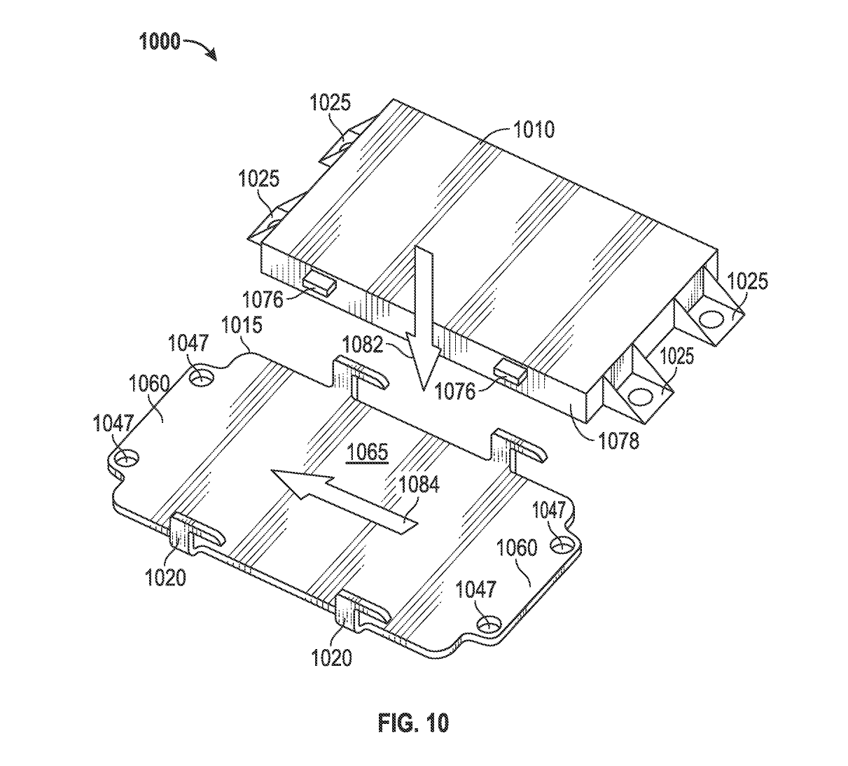

FIG. 10 is an illustration of a mounting system 1000 according to another implementation. The mounting system 1000 can include a vehicle pad cover or “tray” 1010 and a vehicle pad shield 1015. The vehicle pad cover 1010 can include plastic or other suitable material. The vehicle pad shield 1015 can include aluminum or other suitable material. The vehicle pad shield 1015 includes shield attachment interfaces formed along the periphery of a generally planar base area 1065 of the vehicle pad shield 1015. In this implementation, the shield attachment interfaces include clips 1020 in the shape of a single L (“single-L clips”). The single-L clips 1020 extend in a direction generally perpendicular to the base area 1065. While four (4) single-L clips are included in this implementation, more or fewer clips can be included. The single-L clips accept prongs 1076, or other suitable connectors, integrally formed and/or provided on an outer surface 1078 of the vehicle pad cover 1010. More or fewer prongs 1076 can be provided on the vehicle pad cover 1010.

In one implementation, the vehicle pad cover 1010 and the vehicle pad shield 1015 are coupled by lowering the vehicle pad cover 1010 onto the vehicle pad shield 1015 in the direction of arrow 1082, then sliding the vehicle pad cover 1010 along the base area 1065 of the vehicle pad shield 1015 in the direction of arrow 1084. This motion in the direction of arrow 1084 can lock the prongs 1076 into the single-L clips 1020 to securely lock or attach the vehicle pad cover 1010 into place on the vehicle pad shield 1015 to form an assembled vehicle charging pad. It will be understood that while this implementation illustrates the engagement mechanism with downward and leftward motions, upward and rightward motions are also appropriate depending on the relative positions of the vehicle pad cover 1010 and the vehicle pad shield 1015.

In some cases, the vehicle pad cover 1010 and the vehicle pad shield 1015 can be secured together with additional features included in the mounting system 1000. In this implementation, the vehicle pad shield 1015 is a generally rectangular planar structure which includes two longitudinally extending tabs 1060 extending from each of the shorter sides of the rectangular structure. The vehicle pad shield 1015 need not be generally rectangular, and other shapes are possible. In the illustrated implementation, mounting apertures 1047 are formed near the corners of the longitudinally extending tabs 1060 of the vehicle pad shield 1015. The vehicle pad cover 1010 includes mounting brackets 1025 which align with the mounting apertures 1047 of the vehicle pad shield 1015 after the vehicle pad cover 1010 is moved in the direction of arrow 1084 and prongs 1076 engage single-L clips 1020. Fasteners, such as bolts, screws, rivets, or nails or any other suitable component, can pass through the mounting apertures 1047 and the mounting brackets 1025 to securely engage the vehicle pad cover 1010 and the vehicle pad shield 1015. In some implementations, the fasteners passing through the mounting apertures 1047 and the mounting brackets 1025 are also used to attach the assembled vehicle charging pad to another structure, such as a vehicle underbody or frame.

While the implantation of the vehicle pad shield 1015 illustrated in FIG. 10 includes longitudinally extending tabs 1060 having mounting apertures 1047, implementations of the vehicle pad shield 1015 need not include longitudinally extending tabs. For example, as in the implementation illustrated with reference to FIG. 6, the vehicle pad cover 1010 may be secured to the vehicle pad shield solely through engagement of the prongs 1076 with single-L clips 1020, with the assembled vehicle charging pad can then be mounted to the vehicle underbody or frame by passing fasteners just through the mounting brackets 1025 provided on the vehicle pad cover 1010.

In another implementation, the vehicle pad shield 1015 having single-L clips 1020 is integrally formed in the vehicle underbody or frame, and the vehicle pad cover 1010 is attached to the integrated shield by moving the vehicle pad cover in an upward direction into contact with the base area 1065 of the vehicle pad shield 1015, and then to the left or right to lock the prongs 1076 into engagement with the single-L clips 1020. In an implementation where the vehicle pad shield 1015 includes longitudinally extending tabs 1060, fasteners passing through mounting brackets 1025 and tabs 1060 can be configured to securely lock the vehicle pad shield 1015 and the vehicle pad cover 1010 together, as well as to secure the assembled vehicle charging pad to the vehicle underbody or frame. In implementations of the vehicle pad shield 1015 that do not include longitudinally extending tabs 1060, fasteners passing through mounting brackets 1025 on the vehicle pad cover 1010 can be configured to securely attach the assembled vehicle charging pad to the vehicle underbody or frame.

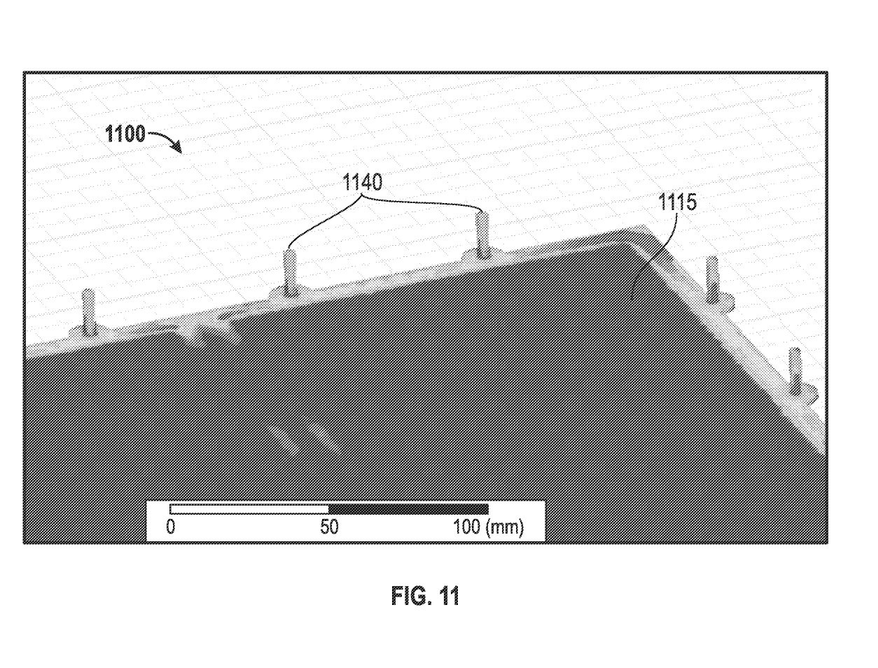

FIG. 11 is an illustration of a magnetic simulation of a mounting system 1100 according to another implementation. The mounting system 1100 includes a vehicle pad shield 1115, which can include aluminum. The vehicle pad shield 1100 includes shield screws 1140. The shield screws 1140 can be adapted to attach a vehicle pad cover (not illustrated in FIG. 11) to the vehicle pad shield 1115. The shield screws 1140 can be made of various materials, such as aluminum or other non-metallic material, such as plastic or polyetheretherketone, for example. The shield screws 1140 in the illustrated implementation include aluminum and can reduce magnetic loss of impact, as shown in the magnetic simulation depicted in FIG. 11. The lighter shaded areas depicted in FIG. 11 depict higher surface heat loss, while the darker shaded areas depict very little or substantially no surface heat loss, such that the lighter shaded areas represent larger amounts of surface heat loss than the darker shaded areas. The results of the magnetic simulation depicted in FIG. 11 illustrates that minimal loss of efficiency and very little magnetic loss is associated with aluminum shield screws 1140 included in this implementation.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

Various modifications of the above described embodiments will be readily apparent, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A vehicle wireless charging pad mounting system, the system comprising:
a vehicle pad cover adapted to enclose a vehicle wireless charging pad; and
a vehicle pad shield having a base area comprising a generally planar surface, the vehicle pad shield comprising shield attachment interfaces adapted to attach the vehicle pad cover to the vehicle pad shield, the shield attachment interfaces integrally formed in the vehicle pad shield and extending in a direction generally perpendicular to the base area of the vehicle pad shield.

2. The system of claim 1, wherein the shield attachment interfaces include clips adapted to receive prongs included on the vehicle pad cover.

3. The system of claim 2, wherein the shield attachment interfaces include closed clips having a generally rectangular surface and a generally rectangular aperture formed in the rectangular surface.

4. The system of claim 2, wherein the clips are in the shape of a double-L.

5. The system of claim 2, wherein the clips are in the shape of a single-L.

6. The system of claim 2, wherein the prongs are in the shape of a rectangular or a T.

7. The system of claim 1, wherein the vehicle pad cover includes a mounting bracket integrally formed in the vehicle pad cover and configured to receive a fastener.

8. The system of claim 7, wherein the mounting bracket is adapted to mount the vehicle pad cover and the vehicle pad shield to a vehicle.

9. The system of claim 7, wherein the mounting bracket is adapted to mount the vehicle pad cover to a vehicle having a vehicle pad shield integrally formed in a vehicle.

10. The system of claim 1, wherein the vehicle pad shield is integrated into an underbody or a frame of a vehicle.

11. A system for mounting a vehicle wireless charging pad to the underbody or the frame of a vehicle, the system comprising a vehicle pad cover enclosing the vehicle wireless charging pad, the vehicle pad cover having a generally planar surface and shield attachment interfaces adapted to attach the vehicle pad cover to a vehicle pad shield, the shield attachment interfaces integrally formed in the cover and extending in a direction generally perpendicular to the base area of the cover.

12. The system of claim 11, wherein the shield attachment interfaces include clips adapted to receive prongs included on the vehicle pad shield.

13. The system of claim 12, wherein the shield attachment interfaces include closed clips having a generally rectangular surface and a generally rectangular aperture formed in the rectangular surface.

14. The system of claim 12, wherein the clips are in the shape of a double-L.

15. The system of claim 12, wherein the clips are in the shape of a single-L.

16. The system of claim 12, wherein the prongs are in the shape of a rectangle or a T.

17. The system of claim 11, wherein the vehicle pad cover includes a plurality of mounting brackets integrally formed in the vehicle pad cover and configured to receive a fastener.

18. A vehicle wireless charging pad mounting system, the system comprising:
a vehicle pad cover adapted to enclose a vehicle wireless charging pad; and
means for shielding the vehicle wireless charging pad, the shielding means including means for attaching the shielding means to the vehicle pad cover, the attaching means integrally formed in the shielding means and extending in a direction generally perpendicular to the shielding means.

19. The system of claim 18, wherein the attaching means include closed clips having a generally rectangular surface and a generally rectangular aperture formed in the rectangular surface, clips in the shape of a double-L, or clips in the shape of a single-L.

20. The system of claim 18, wherein the shielding means is integrated into an underbody or a frame of a vehicle.

21. The system of claim 18, further comprising means for mounting the vehicle pad cover to an electric vehicle.

22. The system of claim 21, wherein the mounting means comprises a plurality of mounting brackets integrally formed in the vehicle pad cover and configured to receive a fastener.
